(19) United States
(12) Patent Application Publication
(10) Pub. No.: US 2026/0162525 A1
(43) Pub. Date: Jun. 11, 2026

(54) MOBILE BODY, MANAGEMENT SERVER, DATA TRANSMISSION METHOD, AND RECORDING MEDIUM

(71) Applicant: NEC Corporation, Minato-ku, Tokyo (JP)

(72) Inventors: Sawaka Seki, Tokyo (JP); Takumi Shiba, Tokyo (JP); Takashi Nunomoto, Tokyo (JP); Seito Nagashima, Toyota (JP); Hitomi Ito, Tokyo (JP); Masaru Yanai, Tokyo (JP); Kosei Kobayashi, Tokyo (JP)

(73) Assignee: NEC Corporation, Minato-ku, Tokyo (JP)

(21) Appl. No.: 18/708,234

(22) PCT Filed: Mar. 14, 2022
(86) PCT No.: PCT/JP2022/011249

§ 371 Date: May 8, 2024

(51) Int. Cl. G08G 1/01; G08G 1/16; H04W 4/46; H04W 4/90

(52) U.S. Cl. CPC G08G 1/0141; G08G 1/0112; G08G 1/0145; G08G 1/161; G08G 1/166; H04W 4/46; H04W 4/90

(57) ABSTRACT

To provide a shared foundation of data measured by a mobile body.

This mobile body comprises: a sensor capable of measuring sensing target data; a storage unit for storing, for each type of sensing target data, a first area, which indicates a geographical range in which the sensor is used to perform measurements, in association with a second area, which indicates a geographical range for transmitting the measured data; a measurement control unit for detecting that the first area has been entered, and for measuring data corresponding to the first area; and a transmission unit for detecting that the second area has been entered, and for transmitting the measured data to a transmission destination located in the second area.

### TECHNICAL FIELD

The present invention relates to a mobile body, a management server, a data transmission method, and a recording medium.

### BACKGROUND ART

PTL 1 discloses an automatic imaging management device capable of acquiring an image having a higher value for a user. According to PTL 1, the automatic imaging management device includes a specifying unit that specifies an imaging unit in which position information of the imaging unit and a direction in which the imaging unit can capture an image match a predetermined imaging area and a predetermined imaging direction, and a request unit that makes a request for the imaging unit specified by the specifying unit to capture an image. For example, the automatic imaging management device causes a second mobile body traveling in parallel with a first mobile body to capture an image including the first mobile body on which a certain user rides, and provides the image to the user.

PTL 2 discloses a blind spot information request device capable of making a request for another vehicle to provide useful image information for compensating a blind spot of a driver.

### CITATION LIST

### Patent Literature

PTL 1: JP 2020-126536 A

PTL 2: JP 2008-299676 A

### SUMMARY OF INVENTION

### Technical Problem

In the invention of PTL 1, there is a problem that an image desired by a user cannot be obtained unless an automatic imaging management device grasps an imaging unit (mobile body) that can provide the image desired by the user. In the invention of PTL 2, there is a problem that an image of a blind spot area cannot be obtained unless a vehicle making a request for the image of the blind spot area transmits blind spot area information to a vehicle that captures the image.

An object of the present invention is to provide a mobile body, a management server, a data transmission method, and a recording medium capable of providing a sharing platform for data measured by the mobile body.

### Solution to Problem

According to a first aspect, there is provided a mobile body including a sensor capable of measuring sensing target data, storage means that stores a first area representing a geographical range in which measurement using the sensor is performed and a second area representing a geographical range to which measured data is to be transmitted, in association with each other, measurement control means that detects that a user has entered the first area and to measure data related to the first area, and transmission means that transmits the measured data to a transmission destination located in the second area.

According to a second aspect, there is provided a data transmission method including detecting entry into a first area representing a geographical range in which measurement is performed by using a sensor capable of measuring sensing target data, and measuring data related to the first area, and transmitting the measured data to a transmission destination located in a second area representing a geographical range to which the measured data associated with the first area is to be transmitted.

According to a third aspect, there is provided a computer-readable recording medium storing a program that causes a computer to execute a process of detecting entry into a first area representing a geographical range in which measurement is performed by using a sensor capable of measuring sensing target data, and measuring data related to the first area, and a process of transmitting the measured data to a transmission destination located in a second area representing a geographical range to which the measured data associated with the first area is to be transmitted.

### Advantageous Effects of Invention

According to the present invention, a mobile body, a management server, a data transmission method, and a recording medium capable of providing a sharing platform of data measured by the mobile body are provided.

### BRIEF DESCRIPTION OF DRAWINGS

FIG. 1 is a view illustrating a configuration of an example embodiment of the present invention.

FIG. 2 is a flowchart illustrating an operation of the example embodiment of the present invention.

FIG. 3 is a view illustrating the operation of the example embodiment of the present invention.

FIG. 4 is another view illustrating the operation of the example embodiment of the present invention.

FIG. 5 is a view illustrating a configuration of a first example embodiment of the present invention.

FIG. 6 is a view illustrating an example of setting information retained in storage means of a vehicle according to the first example embodiment of the present invention.

FIG. 7 is a view illustrating a first area and a second area relevant to the setting information in FIG. 6.

FIG. 8 is a flowchart illustrating an operation of the first example embodiment of the present invention.

FIG. 9 is a view illustrating a configuration of a second example embodiment of the present invention.

FIG. 10 is a flowchart illustrating an operation of the second example embodiment of the present invention.

FIG. 11 is a view illustrating the operation of the second example embodiment of the present invention.

FIG. 12 is a view illustrating a configuration of a third example embodiment of the present invention.

FIG. 13 is a view illustrating an operation of the third example embodiment of the present invention.

FIG. 14 is a view illustrating the operation of the third example embodiment of the present invention.

FIG. 15 is a view illustrating a configuration of a fourth example embodiment of the present invention.

FIG. 16 is a view illustrating an example of setting information retained in storage means of a vehicle according to the fourth example embodiment of the present invention.

FIG. 17 is a view illustrating an operation of the fourth example embodiment of the present invention.

FIG. 18 is a view illustrating a configuration of a computer mounted on a mobile body of the present invention.

### EXAMPLE EMBODIMENT

First, an outline of an example embodiment of the present invention will be described with reference to the drawings. Reference numerals in the drawings given to the outline are given to each element for convenience as an example for assisting understanding, and are not intended to limit the present invention to the illustrated aspects. Connection lines between blocks in the drawings and the like referred to in the following description include both bidirectional and unidirectional. The unidirectional arrow schematically indicates a flow of a main signal (data), and does not exclude bidirectionality. A program is executed via a computer device, and the computer device includes, for example, a processor, a storage device, an input device, a communication interface, and a display device as necessary. The computer device is configured to be able to communicate with a device (including a computer) inside or outside the device via a communication interface regardless of wired or wireless. Although ports and interfaces exist at connection points of input and output of each block in the drawing, illustration thereof is omitted.

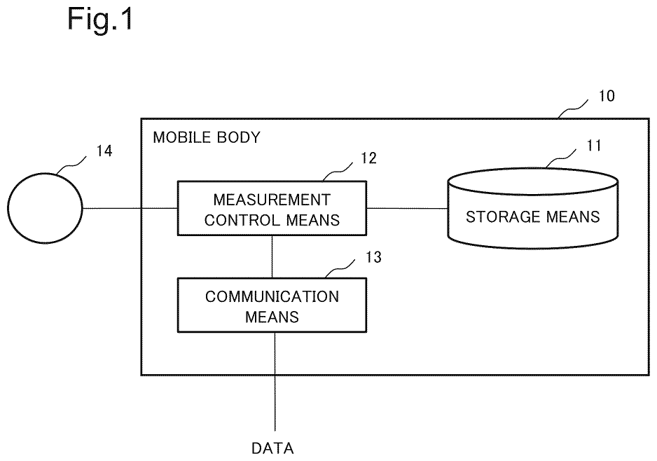

In an example embodiment, as illustrated in FIG. 1, the present invention can be achieved by a mobile body 10 including a sensor 14 capable of measuring sensing target data, storage means 11, measurement control means 12, and transmission means 13.

More specifically, the storage means 11 stores a first area indicating a geographical range in which measurement using a sensor capable of measuring sensing target data is performed and a second area indicating a geographical range in which measured data is transmitted in association with each other.

The measurement control means 12 detects that a user has entered the first area, and measures data related to the first area.

The transmission means 13 transmits the measured data to a transmission destination located in the second area.

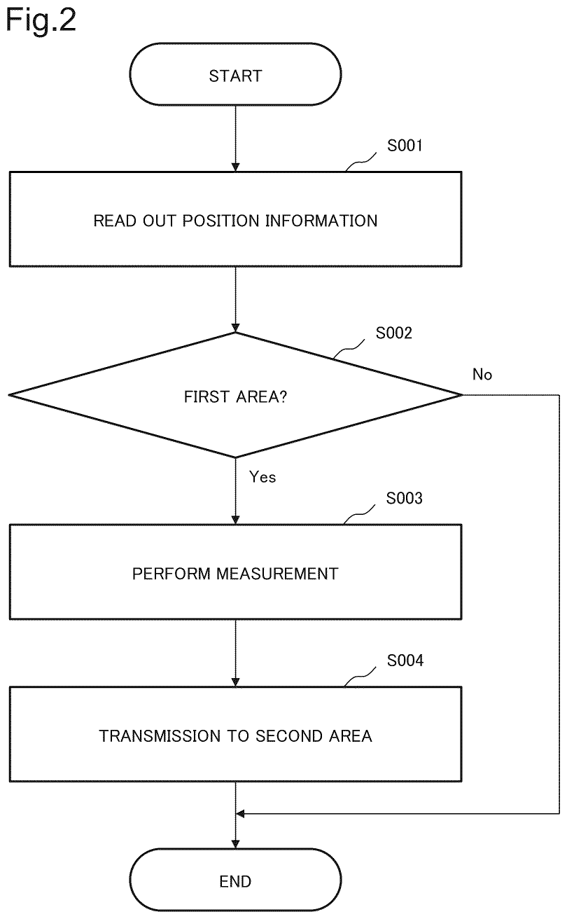

FIG. 2 is a flowchart illustrating an operation of the mobile body described above. First, the mobile body 10 reads position information of a host device (step S001), and determines whether the host device has entered the first area where measurement using the sensor 14 is to be performed (step S002).

As a result of the determination, when it is determined that the mobile body has entered the first area (YYes in step S002), the mobile body 10 performs measurement by the sensor 14 (step S003).

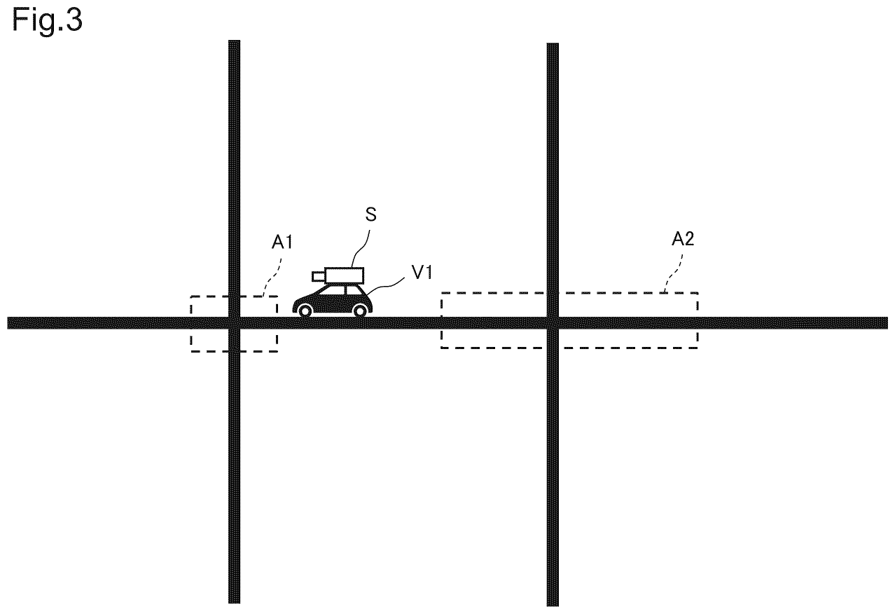

FIG. 3 is a view illustrating the operation of the present example embodiment. In FIG. 3, a vehicle V1 is a mobile body and includes a sensor S. An area that is denoted by a reference numeral Al and is occupied by a broken line in FIG. 3 is a first area, and an area denoted by a reference numeral A2 is a second area. For example, the first area is set at an intersection without a traffic signal. The second area is set around the intersection without such a traffic signal.

For example, the vehicle V1 traveling from a right side to a left side in FIG. 3 measures the inside of an intersection Al using the sensor S at the timing of entering the first area installed at the intersection.

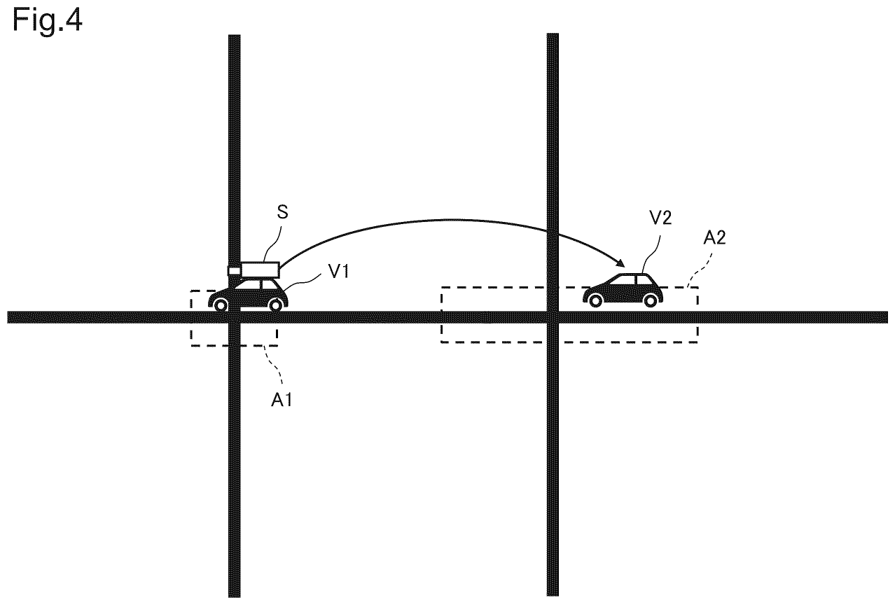

Thereafter, as illustrated in FIG. 4, the mobile body 10 transmits the data measured by the sensor S to a transmission destination (vehicle V2) located in the second area A2 (step S004).

According to the present example embodiment operating as described above, it is possible to share data obtained in one vehicle V1 with another vehicle by setting appropriate conditions for data transfer in the storage means in advance. As a result, for example, it is possible to transmit a situation or the like inside the intersection to other vehicles and to use the situation or the like for prevention of an accident and implementation of safe driving.

In the example embodiment described above, an example in which the mobile body is the vehicle V1 and the transmission destination is the vehicle V2 has been described, but the mobile body and the transmission destination are not limited to the vehicles. For example, the mobile body may be a railway vehicle, an unmanned aerial vehicle (UAV), an automatic guided vehicle, or the like. The transmission destination may also be an information collection device installed in the second area, for example, an Internet of Things (IoT) gateway, or the like, in addition to the railway vehicle, the UAV, and the automatic guided vehicle described above.

### First Example Embodiment

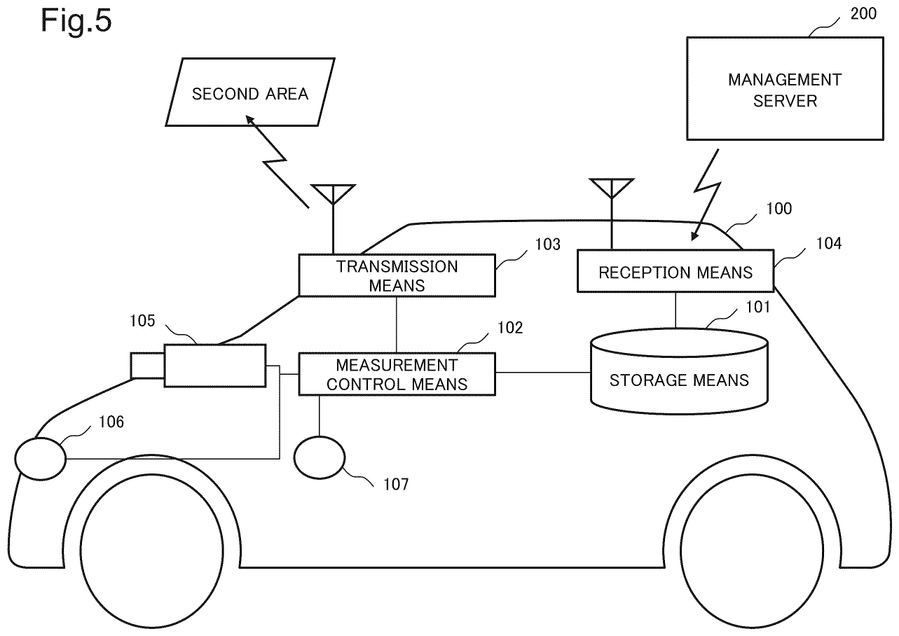

First, a first example embodiment of the present invention will be described in detail with reference to the drawings. FIG. 5 is a view illustrating a configuration of the first example embodiment in which the present invention is applied to a vehicle. In FIG. 5, a vehicle 100 capable of receiving data from a management server 200 and transmitting the data to the second area is shown.

The management server 200 is a server that transmits information (hereinafter, referred to as “setting information”) to be retained in storage means 101 of a vehicle 100 to the vehicle 100. As a communication method between the management server 200 and the vehicle 100, various methods such as a method using a mobile communication network and an aspect of using a roadside machine or the like installed around a road can be used.

The vehicle 100 includes storage means 101, measurement control means 102, transmission means 103, reception means 104, a camera 105, a LiDAR 106, and a GPS 107.

The reception means 104 receives the setting information from the management server 200, and transmits the received setting information to the storage means 101.

As the camera 105, an in-vehicle drive recorder or various in-vehicle cameras for driving assistance can be used. In the following description, it is assumed that the vehicle 100 includes a front camera that captures an image of a forward side of the vehicle 100 and right and left side cameras that capture images of the sides.

The light detection and ranging (LiDAR) 106 is a sensor for detecting an obstacle around the vehicle. The camera 105 and the LiDAR 106 are examples of sensors included in the vehicle 100, and instead of these, other sensors such as an infrared sensor and a millimeter wave sensor can be controlled by the measurement control means 102.

A global positioning system (GPS) 107 is means for acquiring position information of the vehicle 100.

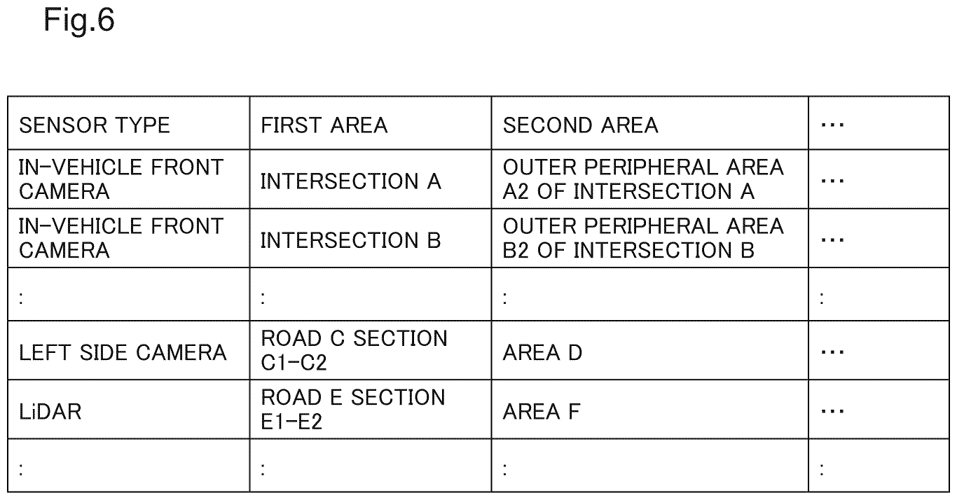

In order to enable setting of the first area and the second area for each type of sensing target data, the storage means 101 stores the setting information received from the management server 200. FIG. 6 is a view illustrating an example of the setting information retained by the storage means 101. Referring to FIG. 6, the setting information configured by entries in which the first area and the second area are associated with each other is illustrated for each sensor type. The measurement by the sensor of the vehicle 100 and the transmission operation of the sensor are defined by the setting information. For example, a first entry from the top in FIG. 6 defines that a camera image of the intersection A is captured by an in-vehicle front camera, and the captured image is transmitted to an area A2 set at an outer periphery of the intersection A. Similarly, a second entry from the top in FIG. 6 defines that an image of an intersection B different from the intersection A is captured by the in-vehicle front camera, and the captured image is transmitted to an area B2 set at an outer periphery of the intersection B. In the example of FIG. 6, for convenience of explanation, ranges of the first and second areas are described as “intersection A”, “road C section C1-C2”, and the like, but these are desirably described in the same coordinate system of the coordinate information acquired by the GPS 107.

A third entry from the top in FIG. 6 defines that an image of a section C1-C2 of a road C is captured by the in-vehicle left side camera, and the captured image is transmitted to the area D. A fourth entry from the top in FIG. 6 defines that the LiDAR measures a section E1-E2 of a road E and transmitted the data to an area F. In the example of FIG. 6, one entry designates one first area and one second area, but two or more first areas and two or more second areas may be set in one entry.

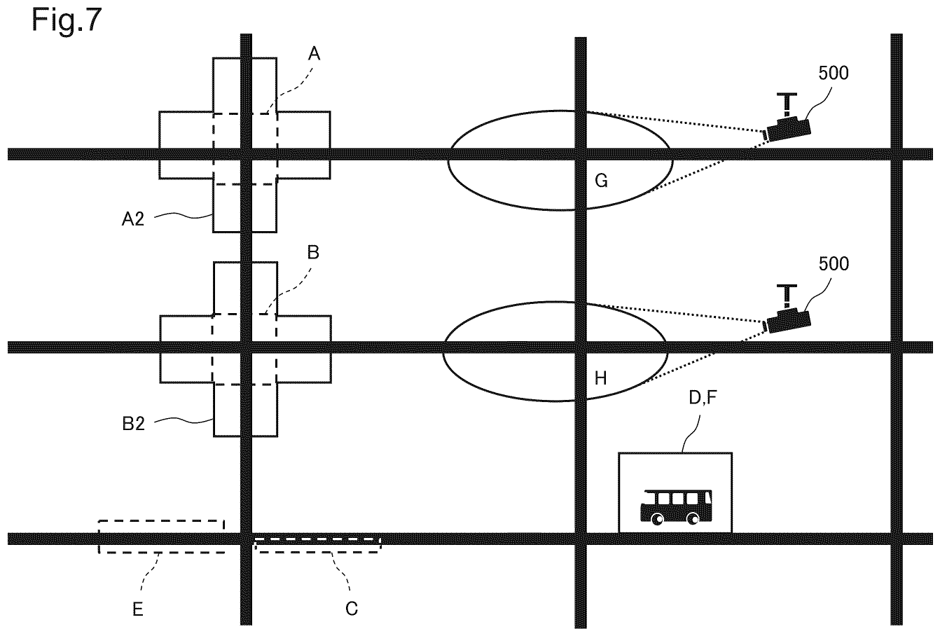

FIG. 7 is a view schematically illustrating the first area and the second area relevant to the setting information in FIG. 6 described above. Intersections denoted by reference numerals G and H in FIG. 7 indicate intersections monitored by a camera 500. Intersections denoted by reference numerals A and B indicate intersections not monitored by a camera 500. When setting these intersections A and B in the first area of the setting information, it is possible to cause a vehicle passing through the intersections A and B to image the inside of these intersections.

When setting the areas A2 and B2 set at outer peripheries of the intersections A and B in the second area of the setting information, it is possible to transmit images within the intersections to surrounding vehicles.

The area that can be set as the first area is not limited to the intersection. For example, as indicated by a reference numeral C in FIG. 7, a certain section of a left lane of a road can be set as the first area. At this time, the sensor type is set to the left side camera as illustrated in FIG. 6, in such a way that an image of the sidewalk can be captured. Similarly, as indicated by reference sign E in FIG. 7, a certain section of the road can be set as the first area and measured by the LiDAR. As transmission destinations of the images and data, various destinations are considered, but for example, as illustrated in FIG. 7, when setting terminals D and F of an automatic driving vehicle as the second area, the images and data can be transmitted to the automatic driving vehicle.

The measurement control means 102 acquires the position information of the host vehicle from the GPS 107, and performs measurement using the camera 105 or the LiDAR 106 in a case where it is detected that the position of the host vehicle has entered the first area defined in the setting information described above. In addition, the measurement control means 102 gives an instruction for the transmission means 103 to transmit the measured image and data to a transmission destination located in the second area.

In accordance with the instruction from the measurement control means 102, the transmission means 103 transmits the measured image and data to the transmission destination located in the second area. As a method by which the transmission means 103 transmits the measured image and data to the second area, a method using a mobile communication network, a method using road-to-vehicle communication with a roadside device, a method using vehicle-to-vehicle communication, or the like can be used. It is not always necessary to specify the transmission destination, and it is possible to employ a method of broadcasting the transmission destination to the second area, a method of indexing the transmission destination, and individually unicasting or group casting the transmission destination to a specific group in the area by the mobile communication network or a terminal position function on a transportation infrastructure side, or the like. It is also possible to transmit the images and data by combining the communication means. For example, a vehicle in the first area transmits the images and data to a roadside terminal in the first area by road-to-vehicle communication. The roadside terminal in the first area which has received the images and data transmits the images and data to a roadside terminal in the second area via a mobile communication network. The roadside terminal in the second area which has received the images and data transmits the images and data to a vehicle in the second area via a road-to-vehicle communication network.

The storage means 101, the measurement control means 102, the transmission means 103, and the reception means 104 described above can also be arranged in an in-vehicle device of the vehicle 100 having a communication function. In other words, the present invention can also be achieved by causing a computer built in an in-vehicle device to function as each means.

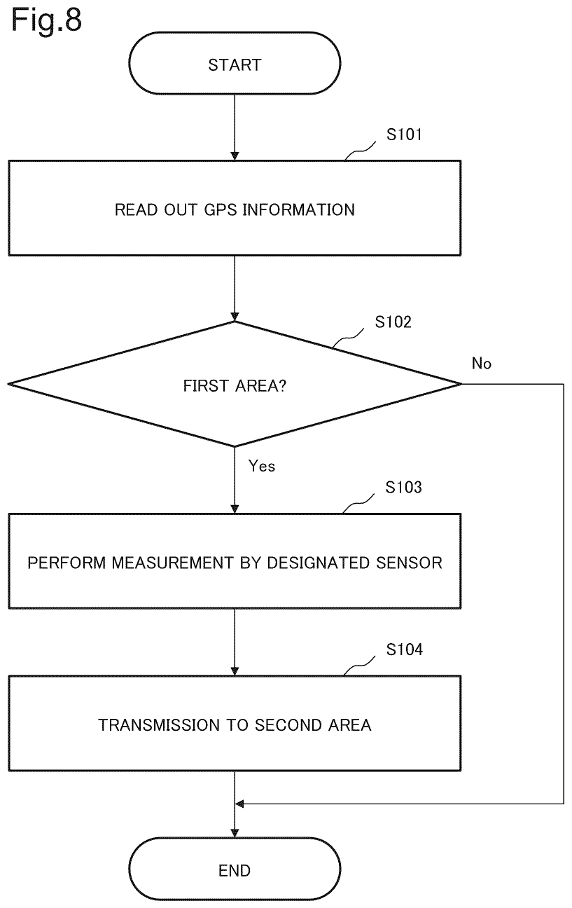

Subsequently, the operation of the present example embodiment will be described in detail with reference to the drawings, and FIG. 8 is a flowchart illustrating the operation of the vehicle 100 of the first example embodiment of the present invention. Referring to FIG. 8, first, the vehicle 100 acquires GPS information indicating a position of a host vehicle (host device) from the GPS 107 (step S101).

Next, the vehicle 100 refers to each entry of the setting information and determines whether the host vehicle has entered the first area (step S102).

As a result of the determination, when it is determined that the host vehicle has entered the first area, the vehicle 100 performs measurement with a sensor (the camera 105 or the LiDAR 106) corresponding to the sensor type of the corresponding setting information (step S103).

Next, the vehicle 100 transmits the sensor data obtained by the measurement to the transmission destination in the second area (step S104). When it is determined in step S102 that the host vehicle has not entered any of the first areas, the vehicle 100 omits the processes in steps S103 and S104 described above.

As described above, the vehicle 100 of the present example embodiment performs measurement by a designated sensor in the first area in accordance with the setting information, and transmits the measurement data to the transmission destination in the second area. Therefore, according to the present example embodiment, it is possible to transmit necessary sensor data to a designated transmission destination without performing any special operation or the like. In other words, when using the configuration of the present example embodiment, it is possible to construct a sharing platform of data measured by the mobile body.

### Second Example Embodiment

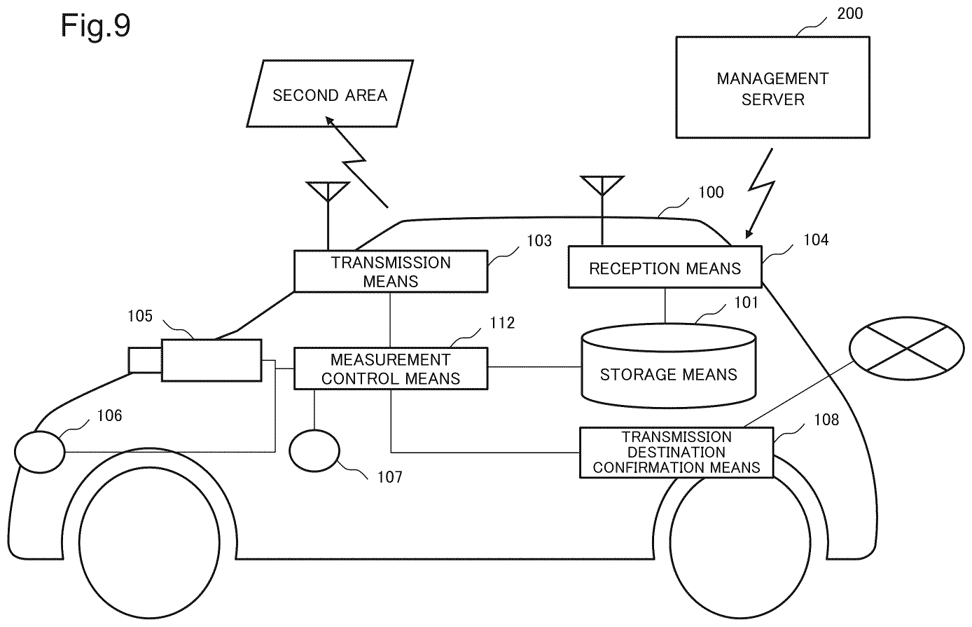

Next, a second example embodiment in which transmission of measurement data is suppressed in a case where a transmission destination is not present in the second area will be described in detail with reference to the drawings. FIG. 9 is a view illustrating a configuration of the second example embodiment of the present invention. A difference from the first example embodiment illustrated in FIG. 5 is that transmission destination confirmation means 108 is added to a vehicle 100a, and the operation of the measurement control means 112 is changed. Since the other configurations are similar to those of the first example embodiment, differences thereof will be mainly described below.

Measurement control means 112 acquires position information of a host vehicle from the GPS 107, and performs imaging or measurement using the camera 105 or the LiDAR 106 in a case where it is detected that the position of the host vehicle has entered the first area defined in the setting information described above. The measurement control means 112 makes a request for the transmission destination confirmation means 108 to confirm whether a transmission destination is present in the second area before giving an instruction for the transmission means 103 to transmit data. As a result of the confirmation, in a case where it is found that there is no transmission destination, the measurement control means 112 suppresses transmission of an image or data. In a case where transmission of the image or data is suppressed, the vehicle 100a may discard the measured image or data, or may retain the image or data for a certain period and attempt retransmission at another timing.

The transmission destination confirmation means 108 uses a network location management service to confirm whether a transmission destination is present in the second area, and returns the result to the measurement control means 112.

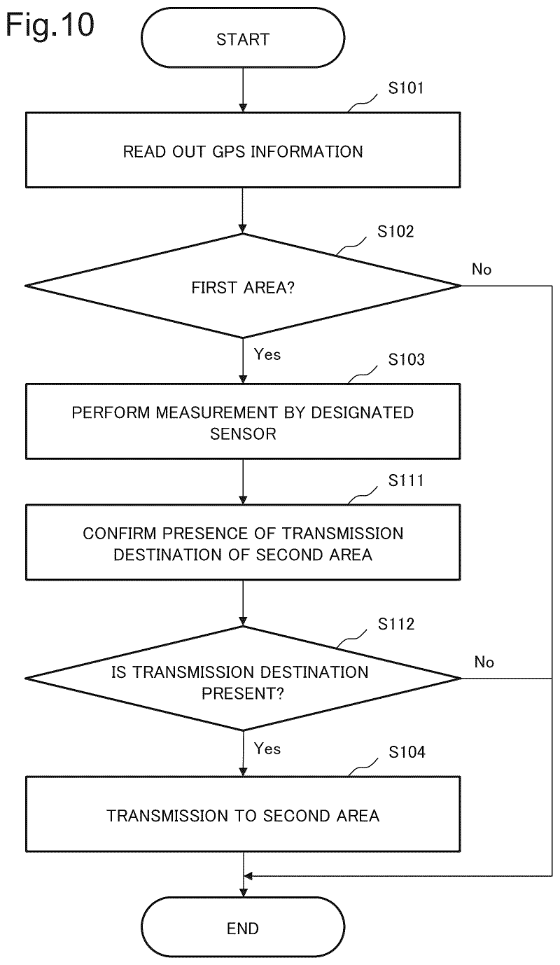

Next, the operation of the present example embodiment will be described in detail with reference to the drawings. FIG. 10 is a flowchart illustrating an operation of the vehicle 100a of the second example embodiment of the present invention. Steps S101 to S103 and S104 in FIG. 10 are the same as those in the first example embodiment, and thus description thereof will be omitted.

In step S103, after the measurement by the sensor is performed, the vehicle 100a confirms whether a destination is present in the second area (step S111). As a result of the confirmation, in a case where it is confirmed that the transmission destination is present in the second area (Yes in step S112), the vehicle 100a transmits the sensor data obtained by the measurement to the transmission destination in the second area (step S104).

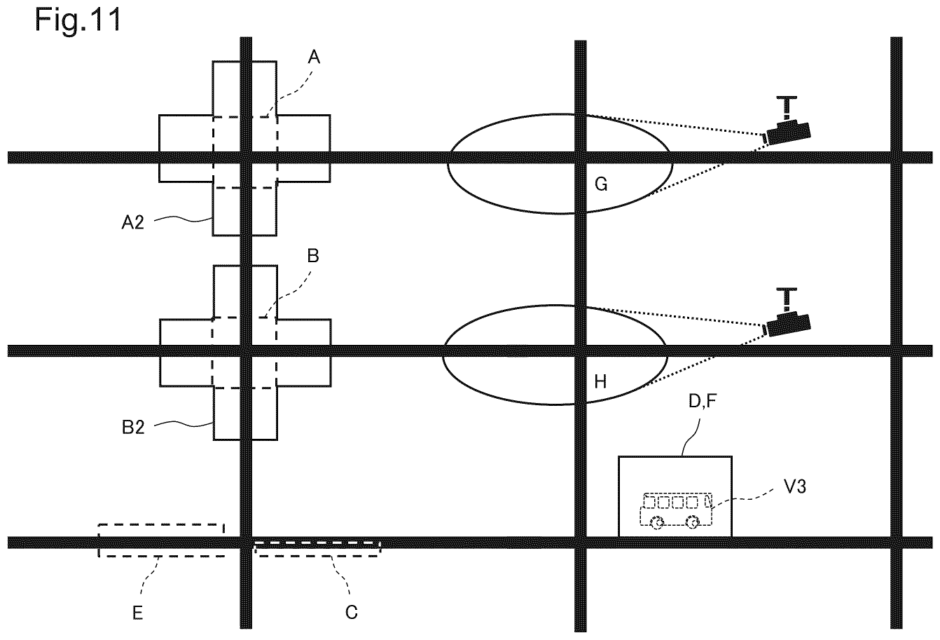

On the other hand, in a case where it is confirmed that the transmission destination is not present in the second area (No in step S112), the measurement control means 112 suppresses transmission of the image and the data. For example, after the data is measured in the first area C or E, as illustrated in FIG. 11, in a case where the vehicle V3 to be the transmission destination is not present in areas of reference numerals D and F which are the second areas, the vehicle 100a suppresses the transmission of the measured image and data. This makes it possible to prevent network resources from being used due to useless data transmission.

### Third Example Embodiment

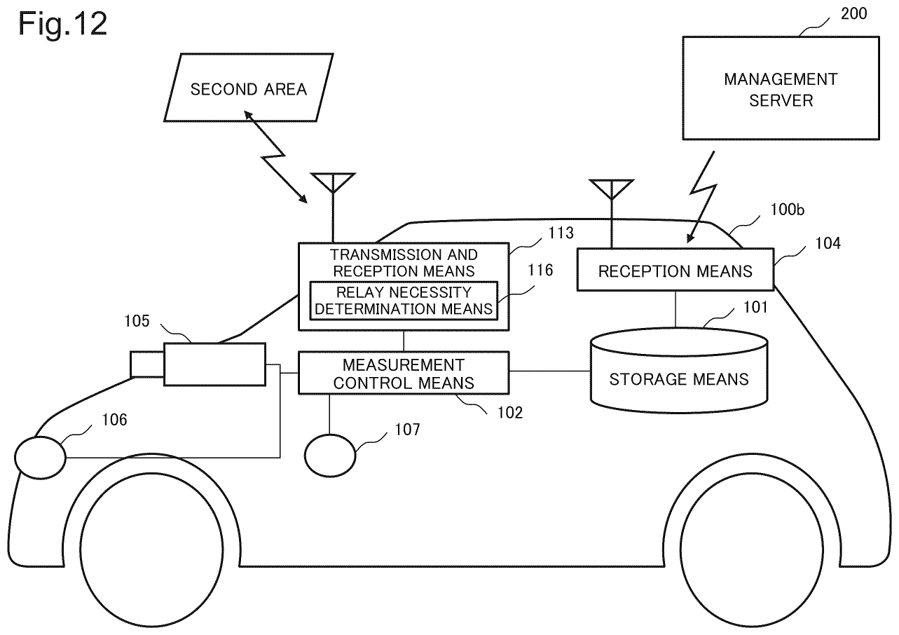

Next, a third example embodiment in which images and data measured by vehicles are transferred by a multi-hop manner by using vehicle-to-vehicle communication will be described in detail with reference to the drawings. FIG. 12 is a view illustrating a configuration of the third example embodiment of the present invention. A difference from the first example embodiment illustrated in FIG. 5 is that the transmission means 103 is replaced with transmission and reception means 113 in a vehicle 100b, and measurement data can be relayed. Since the other configurations are similar to those of the first example embodiment, differences thereof will be mainly described below.

The transmission and reception means 113 functions as reception means that receives images and data transmitted from other mobile bodies (vehicles) by vehicle-to-vehicle communication in addition to transmission function that transmits measured images and data by vehicle-to-vehicle communication. The transmission and reception means 113 can use a communication unit used for vehicle-to-vehicle communication.

The transmission and reception means 113 includes relay necessity determination means 116. The relay necessity determination means 116 determines whether to relay the data received by the reception unit according to whether there is a destination to transmit the data received by the vehicle-to-vehicle communication in the second area. Specifically, the relay necessity determination means 116 determines the relay necessity of the data received by the reception unit based on whether a mobile body other than a transmission source of the data is present in the second area and around the host device. The transmission and reception means 113 transmits the received data according to the relay necessity determination result. That is, in a case where the relay necessity determination result is “necessary”, the transmission and reception means 113 transmits the received data.

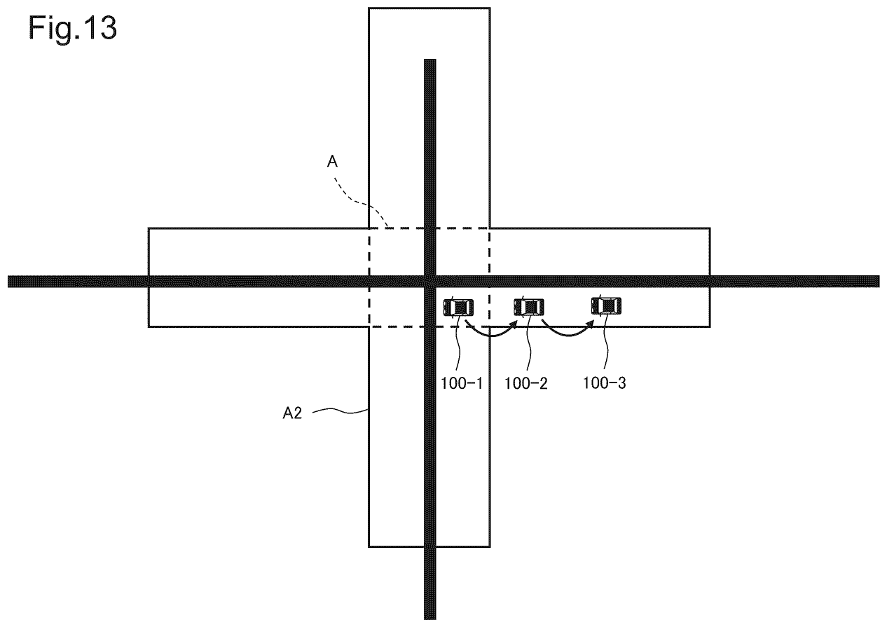

FIG. 13 is a view illustrating an operation of the third example embodiment of the present invention. It is assumed that each of vehicles 100-1 to 100-3 has a function equivalent to that of the vehicle 100b of the present example embodiment. It is assumed that the setting information illustrated in FIG. 6 is retained in the storage means 101 of each of the vehicles 100-1 to 100-3. In the example of FIG. 13, the vehicle 100-1 performs imaging by the front camera according to the setting information, and transfers the captured image to the vehicle 100-2 closest to the vehicle by using vehicle-to-vehicle communication. The operation so far is similar to that of the first example embodiment.

In the present example embodiment, the vehicle 100-1 that has received an image from the vehicle 100-2 determines whether to transfer the image from the vehicle 100-1 based on whether there is a vehicle other than the data transmission source around the host vehicle in the second area (A2 in FIG. 13). In the example of FIG. 13, since the vehicle 100-3 is present, the vehicle 100-2 transfers the image received from the vehicle 100-3 to the vehicle 100-1.

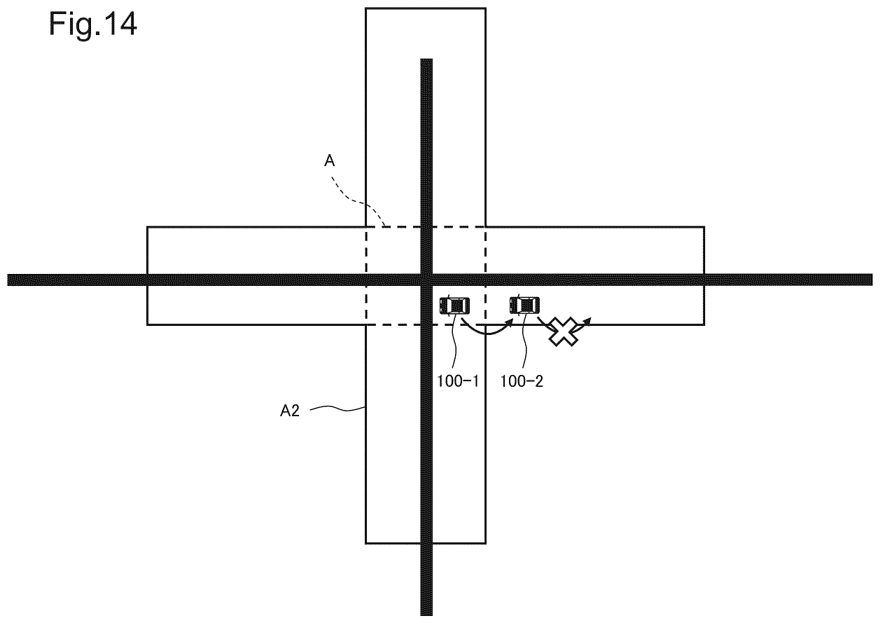

In the case of FIG. 13 in which the vehicle 100-3 that has received the image from the vehicle 100-2 also performs the similar determination, the vehicle 100-3 does not transfer the image because there is no vehicle other than the data transmission source around the host vehicle. In addition, as illustrated in FIG. 14, when there is no vehicle other than the data transmission source around the vehicle 100-2, the vehicle 100-2 does not transfer the image.

As described above, when employing the configuration in which the vehicle 100b transfers the image and data measured by using the vehicle-to-vehicle communication, the image and data measured in the first area can be shared between the vehicles even in an area where the mobile communication network or the road-to-vehicle communication cannot be used.

In the present example embodiment, it has been described that whether to transfer an image from the vehicle 100b is determined based on whether there is a vehicle other than the data transmission source in the second area, but various modifications can be made. For example, it may be determined whether it is necessary to relay the data received by the reception unit based on whether a mobile body other than a transmission source of the data is present within a predetermined range different from the second area. It may be determined whether it is necessary to relay the data received by the reception unit based on whether a mobile body other than a transmission source of the data is present within a predetermined range different from the second area and around the host vehicle.

### Fourth Example Embodiment

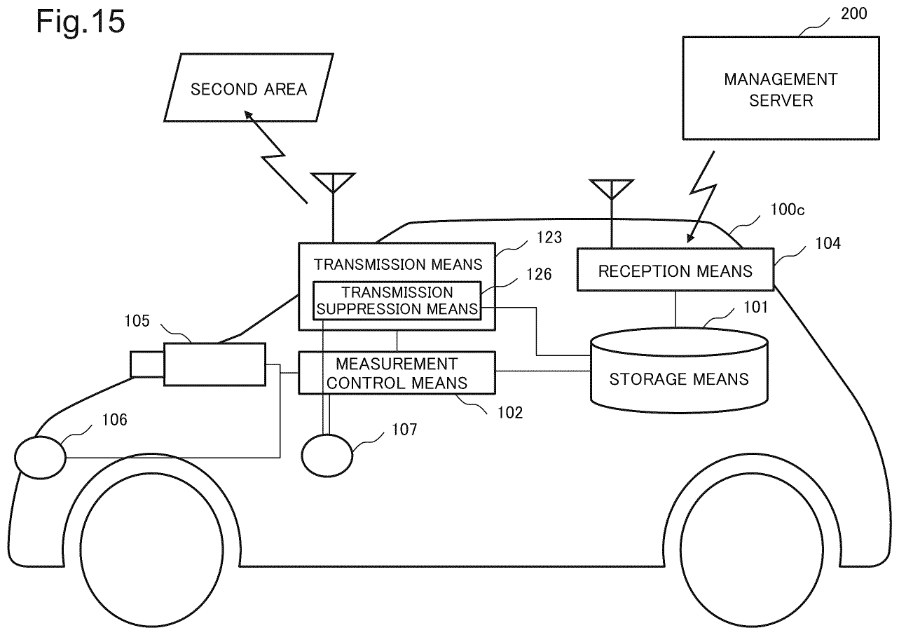

Next, a fourth example embodiment in which a section for suppressing transmission of measured images and data can be set will be described in detail with reference to the drawings. FIG. 15 is a view illustrating a configuration of the fourth example embodiment of the present invention. A difference from the first example embodiment illustrated in FIG. 5 is that transmission means 123 of a vehicle 100c includes transmission suppression means 126, and a function of suppressing transmission of measurement data in a designated area is added. Since the other configurations are similar to those of the first example embodiment, differences thereof will be mainly described below.

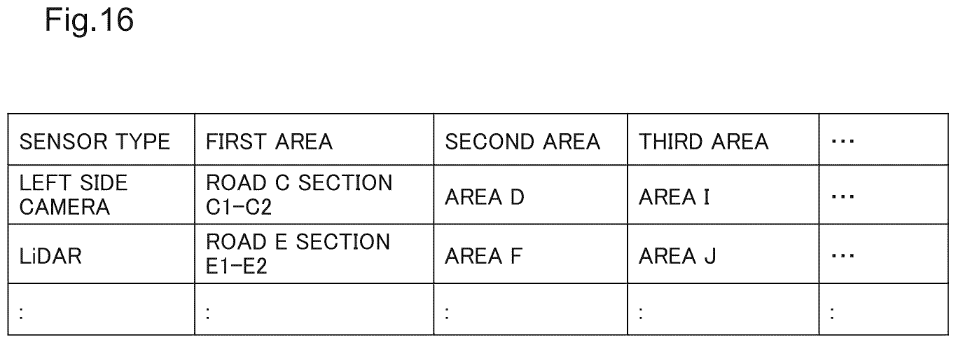

FIG. 16 is a view illustrating an example of setting information retained in storage means 101 of a vehicle 100c according to the present example embodiment. A difference from the setting information of the first example embodiment illustrated in FIG. 6 is that a third area for suppressing transmission of measured data can be set for each entry of the setting information. The first entry from the top in FIG. 16 defines that an image of a section C1-C2 of a road C is captured by an in-vehicle left side camera and the captured image is transmitted to the area D, and transmission in an area I is suppressed. Similarly, a second entry from the top defines that a section E1-E2 of a road E is measured by the LiDAR and the data is transmitted to an area F, and transmission in an area J is suppressed.

The transmission means 123 receives an instruction for transmission of a measured image or data to a transmission destination located in the second area, and information relating to the third area from the measurement control means 102.

The transmission suppression means 126 determines whether the host vehicle is located in the third area based on a position of the host vehicle which is obtained from the GPS 107, and suppresses transmission of data when the host vehicle is located in the third area. In a case where it is detected that the host vehicle has left the third area, the transmission suppression means 126 starts transmission of the suppressed data.

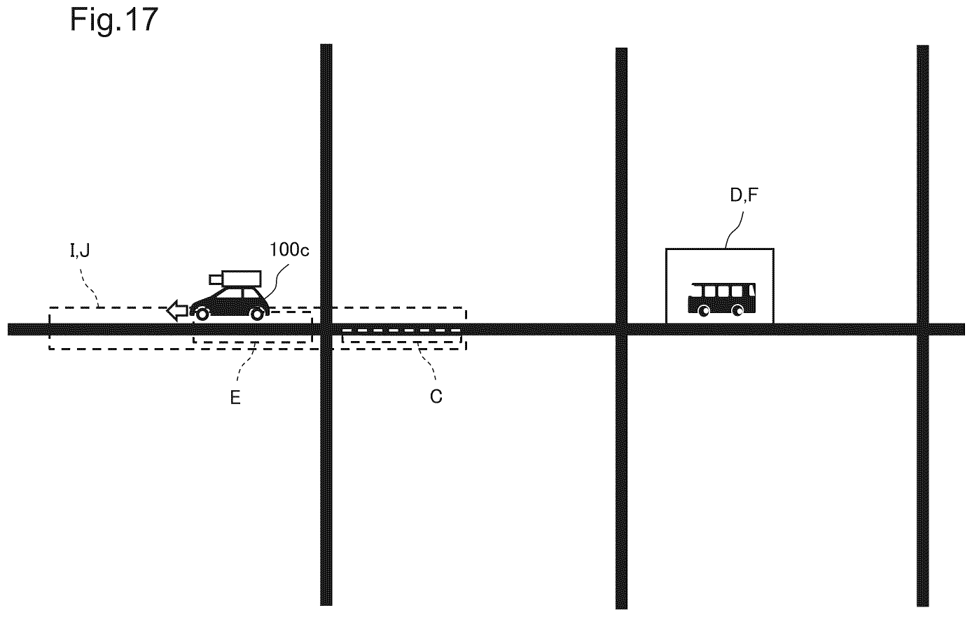

FIG. 17 is a view illustrating an operation of the fourth example embodiment of the present invention. In the example of FIG. 17, the third areas I and J are set in such a way as to include the section C1-C2 (reference numeral C in FIG. 17) of the road C set as the first area. When entering the section C1-C2 (reference numeral C in FIG. 17) of the road C set as the first area in accordance with the setting information, the vehicle 100c performs imaging by the left side camera. On the other hand, since the vehicle 100c is located in the area I set as the third area, transmission of measured data is suppressed. Thereafter, the vehicle 100c starts transmission of the measured data when leaving the area I.

Similarly, when entering a section E1-E2 (reference numeral E in FIG. 17) of the road E according to the setting information, the vehicle 100c performs measurement by the LiDAR 106. On the other hand, since the vehicle 100c is located in the area J set as the third area, transmission of measured data is suppressed. Thereafter, the vehicle 100c starts transmission of the measured data when leaving the area J.

As described above, according to the present example embodiment, it is possible to set an area in which transmission of measured data is prohibited for each data type. As a result, it is possible to avoid interference with an existing communication infrastructure and interference with a bandwidth of the existing communication infrastructure.

Although the example embodiments of the present invention have been described above, the present invention is not limited to the above-described example embodiments, and further modifications, substitutions, and adjustments can be made without departing from the basic technical idea of the present invention. For example, the network configuration, the configuration of each element, and the representation form of data illustrated in the drawings are examples for assisting the understanding of the present invention, and are not limited to the configurations illustrated in the drawings.

For example, in each of the above-described example embodiments, an example in which the mobile body is a vehicle has been described, but the mobile body may be a railway vehicle, a UAV, an automatic guided vehicle, or the like. For example, when being applied to a railway vehicle, it is possible to perform an operation of causing the railway vehicle to perform sensing in order to confirm a state of a track and surrounding facilities and transmitting the result to a terminal of a specific area (second area).

### Regarding Hardware Configuration

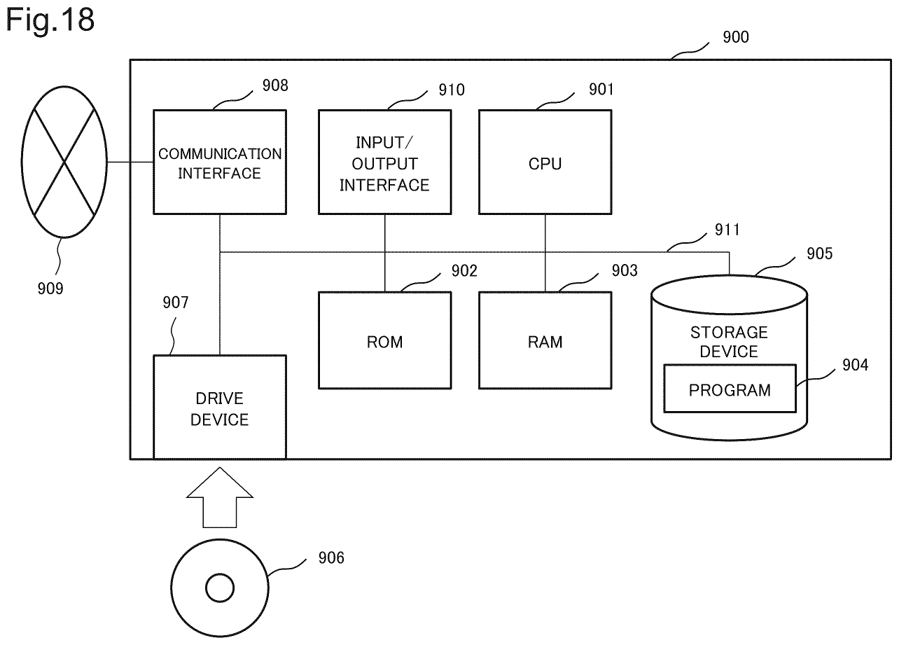

In each example embodiment of the present disclosure, each constituent element of each device indicates a block of a functional unit. Constituent elements of each device are partly or entirely achieved by, for example, any combination of the information processing device 900 and a program as illustrated in FIG. 18. FIG. 18 is a block diagram illustrating an example of a hardware configuration of the information processing device 900 that achieves each constituent element of each device. The information processing device 900 includes the following configuration as an example.
CPU (Central Processing Unit) 901
ROM (Read Only Memory) 902
RAM (Random Access Memory) 903
Program 904 loaded to RAM 903
Storage device 905 that stores the program 904
Drive device 907 for reading the recording medium 906
Communication interface 908 that connects to a communication network 909
Input/output interface 910 that performs input/output of data
Bus 911 that connects constituent elements

Each constituent element of each device in each example embodiment is achieved by the CPU 901 acquiring and executing the program 904 for achieving these functions. That is, the CPU 901 of FIG. 18 may execute a vehicle detection program and a determination program to perform update processing of each calculation parameter stored in the RAM 903, the storage device 905, or the like. The program 904 for achieving the function of each constituent element of each device is stored in the storage device 905 or the ROM 902 in advance, for example, and is read out by the CPU 901 as necessary. The program 904 may be supplied to the CPU 901 via the communication network 909, or may be stored in advance in the recording medium 906, and the drive device 907 may read out the program and supply the program to the CPU 901.

The program 904 can display the processing result including an intermediate state for each stage via a display device as necessary, or can communicate with the outside via the communication interface. The program 904 can be recorded on a computer-readable (non-transitory) recording medium.

There are various modifications of the implementation method of each device. For example, each device may be achieved by any combination of the information processing device 900 and the program which are separate for each constituent element. A plurality of constituent elements included in each device may be achieved by any combination of one information processing device 900 and a program. That is, each unit (processing means and function) of the mobile body (vehicle) described in the above-described first to fourth example embodiments can be achieved by a computer program that causes a processor mounted in the device to execute each of the above-described processes using the hardware.

Constituent elements of each device are partially or entirely achieved by another general-purpose or dedicated circuit, processor, or the like, or a combination thereof. These may be configured by a single chip or may be configured by a plurality of chips connected via a bus.

Constituent elements of each device may be partially or entirely achieved by a combination of the above-described circuit or the like and a program.

In a case where constituent elements of each device are partially or entirely achieved by a plurality of information processing devices, circuits, and the like, the plurality of information processing devices, circuits, and the like may be arranged in a centralized manner or in a distributed manner. For example, the information processing devices, the circuits, and the like may be achieved as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various changes are made.

The whole or part of the example embodiments disclosed above can be described as, but not limited to, the following supplementary notes.

### Supplementary Note 1

A mobile body, including:
a sensor capable of measuring sensing target data;
storage means that stores a first area representing a geographical range in which measurement using the sensor is performed and a second area representing a geographical range to which measured data is to be transmitted, in association with each other;
measurement control means that detects that a user has entered the first area and to measure data related to the first area; and
transmission means that transmits the measured data to a transmission destination located in the second area.

### Supplementary Note 2

The mobile body may further include transmission destination confirmation means that confirms whether the transmission destination is present in the second area, and transmission of the measured data may be suppressed in a case where the transmission destination is not present in the second area.

### Supplementary Note 3

The mobile body may further include reception means that receives the data transmitted from another mobile body by vehicle-to-vehicle communication, and relay necessity determination means that determines whether it is necessary to relay the data received by the reception means based on whether there is a destination to which the data received by the vehicle-to-vehicle communication is to be transmitted, within a predetermined range, and the transmission means may transmit the received data depending on a relay necessity determination result.

### Supplementary Note 4

The relay necessity determination means of the mobile body may determine that the relay necessity of the data received by the reception means based on whether a mobile body other than a transmission source of the data is present within the predetermined range and around a host device.

### Supplementary Note 5

In the mobile body, the first area and the second area may be set for each type of the sensing target data.

### Supplementary Note 6

In the mobile body, information about a third area representing a geographical range in which transmission of the measured data is suppressed may be further retained, and transmission of the measured data may be suppressed when the host device is located in the third area.

### Supplementary Note 7

In the mobile body, the sensing target data may be a camera image, and the first area may be set at an intersection without a traffic signal.

### Supplementary Note 8

In the mobile body, the second area may be set around an intersection without the traffic signal.

### Supplementary Note 9

A management server that transmits, to the mobile body according to any one of the preceding supplementary notes, a type of the sensing target data, information indicating the first area, and information indicating the second area, and stores the type and the information in the storage means of the mobile body.

### Supplementary Note 10

A data transmission method, including:
detecting entry into a first area representing a geographical range in which measurement is performed by using a sensor capable of measuring sensing target data, and measuring data related to the first area; and
transmitting the measured data to a transmission destination located in a second area representing a geographical range to which the measured data associated with the first area is to be transmitted.

### Supplementary Note 11

A computer-readable recording medium storing a program that causes a computer to execute:
a process of detecting entry into a first area representing a geographical range in which measurement is performed by using a sensor capable of measuring sensing target data, and measuring data related to the first area; and
a process of transmitting the measured data to a transmission destination located in a second area representing a geographical range to which the measured data associated with the first area is to be transmitted.

Note that the aspects of Supplementary Notes 9 and 10 described above can be developed in the aspects of Supplementary Notes 2 to 7 as in Supplementary Note 1.

The disclosure of the above patent literature is incorporated herein by reference, and can be used as a basis or a part of the present invention as necessary. Within the scope of the entire disclosure (including claims) of the present invention, it is possible to further modify and adjust the example embodiments or examples further based on the basic technical idea. Various combinations or selections (including partial deletions) of various disclosed elements (including each element of each claim, each element of each example embodiment or example, each element of each drawing, and the like) can be made within the scope of the disclosure of the present invention. That is, it is a matter of course that the present invention includes various modifications and corrections that can be made by those skilled in the art in accordance with the entire disclosure including the claims and the technical idea. In particular, for numerical ranges set forth herein, any numerical value or sub-range included within the range should be construed as being specifically described, even if not stated otherwise. It is also deemed that the matters disclosed in the documents cited above are included in the matters disclosed in the present application to use a part or all of the matters disclosed in the documents in combination with the matters described in the present specification as part of the disclosure of the present invention according to the gist of the present invention as necessary.

### REFERENCE SIGNS LIST

10 mobile body
11 storage means
12 measurement control means
13 transmission means
14 sensor
100, 100a, 100b, 100c, 100-1 to 100-3 vehicle
101 storage means
102, 112 measurement control means
103 transmission means
104 reception means
105 camera
106 LiDAR
107 GPS
108 transmission destination confirmation means
113 transmission and reception means
116 relay necessity determination means
123 transmission means
126 transmission suppression means
200 management server
500 camera
900 information processing device
901 CPU (Central Processing Unit)
902 ROM (Read Only Memory)
903 RAM (Random Access Memory)
904 program
905 storage device
906 recording medium
907 drive device
908 communication interface
909 communication network
910 input/output interface
911 bus
A1, A, B, C, E first area
A2, B2, D, F second area
S sensor
V1, V2, V3 vehicle

What is claimed is:

1. A mobile body, comprising:
a sensor capable of measuring sensing target data;
a memory storing instructions; and
at least one processor configured to execute the instructions to:
store a first area representing a geographical range in which measurement using the sensor is performed and a second area representing a geographical range to which measured data is to be transmitted, in association with each other;
detect that a user has entered the first area and to measure data related to the first area; and
transmit the measured data to a transmission destination located in the second area.

2. The mobile body according to claim 1, wherein
the at least one processor is further configured to execute the instructions to confirm whether the transmission destination is present in the second area, and
transmission of the measured data is suppressed in a case where the transmission destination is not present in the second area.

3. The mobile body according to claim 1, wherein
the at least one processor is further configured to execute the instructions to:
receive the data transmitted from another mobile body by vehicle-to-vehicle communication;
determine whether it is necessary to relay the data received by the reception means based on whether there is a destination to which the data received by the vehicle-to-vehicle communication is to be transmitted, within a predetermined range; and
transmit the received data depending on a relay necessity determination result.

4. The mobile body according to claim 3, wherein
the at least one processor is further configured to execute the instructions to:
determine that the relay necessity of the data received by the reception means based on whether a mobile body other than a transmission source of the data is present within the predetermined range and around a host device.

5. The mobile body according to claim 1, wherein the first area and the second area can be set for each type of the sensing target data.

6. The mobile body according to claim 1, wherein information about a third area representing a geographical range in which transmission of the measured data is suppressed is further retained, and transmission of the measured data is suppressed when the host device is located in the third area.

7. The mobile body according to claim 1, wherein the sensing target data is a camera image, and the first area is set at an intersection without a traffic signal.

8. The mobile body according to claim 7, wherein the second area is set around the intersection without the traffic signal.

9. A management server comprising:
a memory storing instructions; and
at least one processor configured to execute the instructions to:
transmit, to the mobile body according to claim 1, a type of the sensing target data, information indicating the first area, and information indicating the second area; and
store the type and the information in the storage means of the mobile body.

10. A data transmission method, comprising:
detecting entry into a first area representing a geographical range in which measurement is performed by using a sensor capable of measuring sensing target data, and measuring data related to the first area; and
transmitting the measured data to a transmission destination located in a second area representing a geographical range to which the measured data associated with the first area is to be transmitted.

11. A non-transitory computer-readable recording medium storing a program that causes a computer to execute the processes of:
detecting entry into a first area representing a geographical range in which measurement is performed by using a sensor capable of measuring sensing target data, and measuring data related to the first area; and
transmitting the measured data to a transmission destination located in a second area representing a geographical range to which the measured data associated with the first area is to be transmitted.
